(19) United States
(12) Patent Application Publication
(10) Pub. No.: US 2004/0136720 A1
(43) Pub. Date: Jul. 15, 2004

(54) Task prioritization in firmware controlled optical transceiver

(76) Inventors: Peter H. Mahowald, Las Altos, CA (US); Kevin Reid Woolf, Salinas, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/346,916

(22) Filed: Jan. 15, 2003

(51) Int. Cl. H04B 10/00

(52) U.S. Cl. 398/135; 398/22

(57) ABSTRACT

An optical transceiver module for optical communication includes a transmitter, a receiver, and a controller. The controller is coupled to the transmitter and receiver and includes a transceiver operating code. The transceiver operating code includes a plurality of task code modules, with each task code module containing instructions for performing at least one task of a plurality of tasks for controlling the optical transceiver module, and each having an assigned priority level. The transceiver operating code further includes a priority code configured to control the order in which the controller executes the plurality of task code modules based on the assigned priority levels.

### THE FIELD OF THE INVENTION

The present invention relates generally to optical transceiver modules, and more particularly to optical transceiver modules employing a transmitter and receiver operating in conjunction with a controller to control transceiver module operations.

### BACKGROUND OF THE INVENTION

The use of fiber optics technology in data communication continues to expand at a rapid pace. Optic fiber transmission links are used widely in connecting computer, telephone, and instrumentation systems. Fiber optic systems have tremendous advantages over systems utilizing copper conductors. Besides being smaller and lighter than copper conductor systems, fiber optic systems offer total electrical isolation, extremely high-speed wideband capability, and complete immunity to both noise and the broad spectrum of interference. Most importantly, fiber optic communication links are much less expensive than copper conductor systems.

A basic fiber optic communication link has three components: a transmitter, a receiver, and a fiber optic cable. The transmitter contains a light-emitting element that converts an electrical current into an optical signal. The light-emitting element is typically a light-emitting diode, a laser diode, or a vertical cavity surface-emitting laser. The receiver contains a light-detecting element that converts the light signal back into an electrical current. The light-detecting element is commonly a positive-intrinsic-negative photodiode (PIN diode). The fiber optic cable connects the transmitter to the receiver and carries the optical signal between them.

More commonly, however, a fiber optic link comprises a pair of optical transceivers coupled by a pair of fiber optic cables. An optical transceiver combines a transmitter with a receiver to form a single unit that provides all required electrical/optical conversions necessary to both transmit and receive optical data. The transmitter of the first transceiver sends data in the form of an optical signal via one of the fiber optic cables to the receiver of the second transmitter which subsequently converts the optical signal to an electrical signal. Likewise, the transmitter of the second transceiver sends an optical signal via the other fiber optic cable to the receiver of the first transceiver.

Historically, optical transceivers have been constructed as “hard-coded” integrated circuits. In other words, a transceiver constructed in this fashion comprises a plurality of individual circuits designed into an integrated circuit, with each individual circuit comprising a plurality of transistors configured to carry out a single task. While hard-coded designs provide for high-speed transceiver operation, they are rather inflexible and are difficult to modify if they for some reason fail to perform in accordance with design criteria. Often, a redesign and remanufacture of the integrated circuit is required in order to modify or alter a circuit's function or operating parameters. This is of particular concern with regard to circuits whose operations are susceptible to environmental conditions, such as laser biasing circuits.

Also, as the use fiber optic communications continues to grow, transceivers are being designed to perform more and complex functions and users are requesting measurement and reporting of an increasing number of transceiver module operating conditions and parameters. Consequently, the hard-coded circuits required to carryout such tasks are becoming increasingly complex and expensive to design and manufacture, especially if the initial design fails to meet operating criteria. Futhermore, as optical technology continues to advance at a rapid pace, existing transceivers using hard-code designs cannot be adapted to take advantage of new advancements and can quickly become obsolete.

Optical transceiver modules, especially those employing lasers, would benefit from a more flexible control scheme that allows the transceiver to more easily adapt to dynamic operating environments and to incorporate technological advancements in order to provide optimal performance to users.

### SUMMARY OF THE INVENTION

One aspect of the present invention provides an optical transceiver module for optical communication. The optical transceiver module includes a transmitter, a receiver, and a controller. The controller is coupled to the transmitter and receiver and includes a transceiver operating code. The transceiver operating code includes a plurality of task code modules, with each task code module containing instructions for performing at least one task of a plurality of tasks for controlling the optical transceiver module. Each task has an assigned priority level. The transceiver operating code further includes a priority code configured to control the order in which the controller executes the plurality of task code modules based on the assigned priority levels.

### BRIEF DESCRIPTION OF THE DRAWINGS

FIG. 1 is a block diagram illustrating one embodiment of an optical transceiver module according to the present invention.

FIG. 2 is a block diagram illustrating one embodiment of an optical transceiver module according to the present invention.

FIG. 3 is a flow diagram illustrating one exemplary embodiment of a process employed by an optical transceiver module according to the present invention during data communication for prioritizing the a plurality of tasks for controlling the transceiver operation.

FIG. 4 is a flow diagram illustrating one exemplary embodiment of a process employed by an optical transceiver module according to the present invention for monitoring a laser.

FIG. 5 is a flow diagram illustrating one exemplary embodiment of a process employed by an optical transceiver module according to the present invention for prioritizing a plurality of tasks associated with monitoring of the transceiver module.

FIG. 6A is a flow diagram illustrating one exemplary embodiment of a process for initializing a laser of an optical transceiver module according to the present invention.

FIG. 6B is a flow diagram illustrating one exemplary embodiment of a process for initializing a laser of an optical transceiver module according to the present invention.

FIG. 6C is a flow diagram illustrating one exemplary embodiment of a process for initializing a laser of an optical transceiver module according to the present invention.

FIG. 6D is a flow diagram illustrating one exemplary embodiment of a process for initializing a laser of an optical transceiver module according to the present invention.

FIG. 6E is a flow diagram illustrating one exemplary embodiment of a process for initializing a laser of an optical transceiver module according to the present invention.

FIG. 6F is a flow diagram illustrating one exemplary embodiment of a process for improving the initialization of a laser of an optical transceiver module according to the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

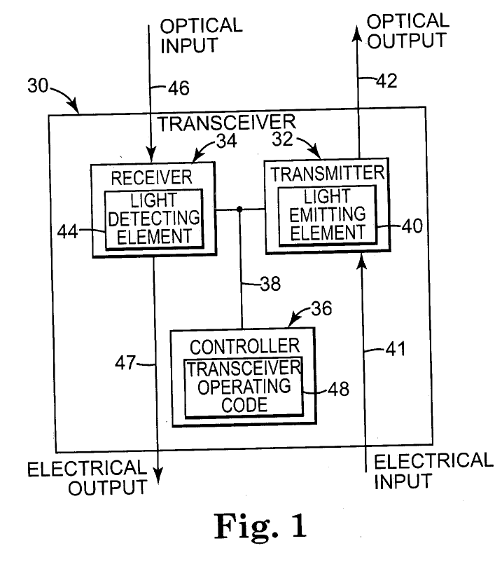

An optical transceiver module according to the present invention is illustrated generally at 30 in FIG. 1. Optical transceiver module 30 includes a transmitter 32, a receiver 34, and a controller 36. Controller 36 is coupled to and communicates with transmitter 32 and receiver 34 via a path 38. Transmitter 32 includes a light-emitting element 40 configured to receive an electrical input signal via a path 41 and to convert the electrical signal to an optical output signal provided via an optical fiber 42. In one embodiment, light-emitting element 40 is a laser. In one embodiment, transmitter 32 is an integrated circuit. Receiver 34 includes a light-detecting element 44 configured to detect an optical input signal received via an optical fiber 46 and to convert the optical input signal to an electrical signal provided via a path 47. In one embodiment, receiver 34 is an integrated circuit.

Controller 36 includes a transceiver operating code 48 and is configured to operate in conjunction with transmitter 32 and receiver 34 to control a plurality of tasks associated with the operation of optical transceiver module 30. Controller 36 includes a transceiver operating code 48 comprising a plurality of task code modules. Each task code module has an assigned priority level, and contains instructions for performing at least one task of a plurality of tasks for controlling the operation of optical transceiver module 30. Transceiver operating code 48 further comprises a priority code configured to control the order in which controller 36 executes the plurality of task code modules based on their assigned priority levels.

By utilizing a controller in conjunction with a transmitter and a receiver, optical transceiver module 30 according to the present invention provides a more flexible optical transceiver design than conventional optical transceivers utilizing “hard coded” integrated circuits. For example, optical transceiver 30 is better configured to and more easily provides monitoring of and reporting to users of transceiver operating characteristics, such as the transceiver's internal temperature, laser output power, and laser biasing. Furthermore, by employing a priority code for executing transceiver module 30 control tasks in order of an assigned priority level, controller 36 provides for reliable transceiver operation by ensuring that higher priority tasks are completed without fail on a frequent basis while still ensuring that lower priority tasks are completed in a timely fashion.

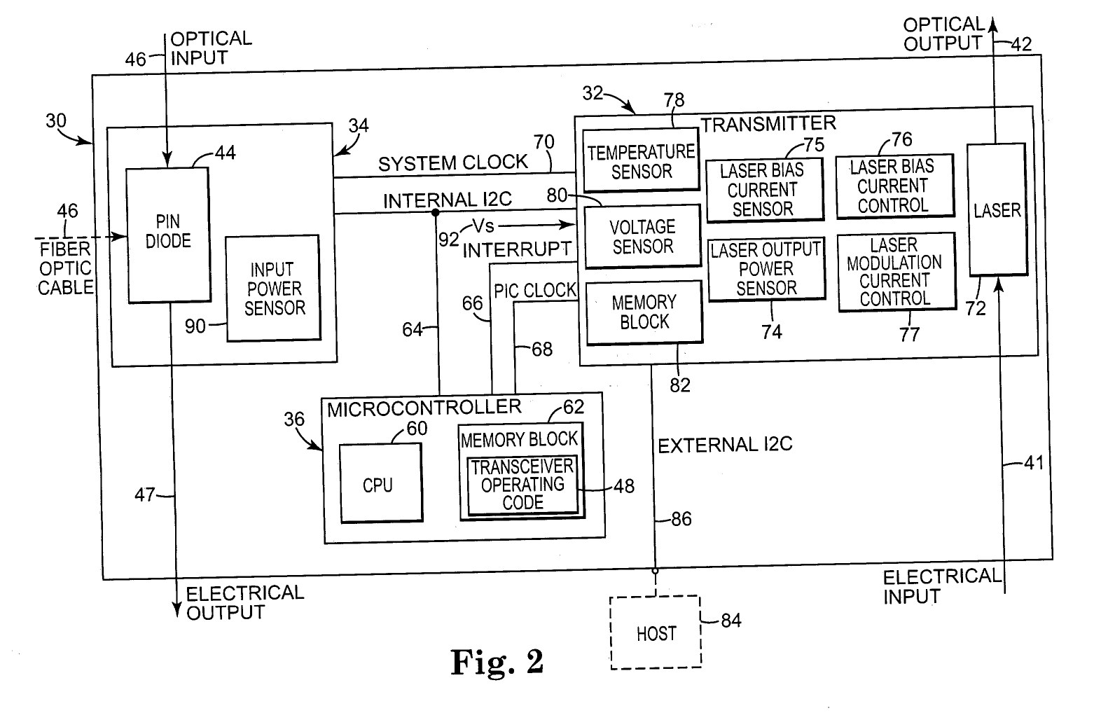

FIG. 2 illustrates one exemplary embodiment of optical transceiver module 30 according to the present invention. Optical transceiver module 30 includes transmitter 32, receiver 34, and controller 36, which in one embodiment is a microcontroller comprising a central processing unit (CPU) 60 and a memory block 62, which further includes transceiver operating code 48. In one embodiment, memory block 62 is an electrically erasable programmable read only memory (EEPROM) device. Microcontroller 36 is electrically coupled to transmitter 34 and receiver 36 via an internal connection 64 which is any suitable type of serial or parallel connection, such as a two-wire serial connection. One suitable serial two-wire connection is an I2C connection as provided by the I2C-Bus Specification available from Phillips Semiconductor at http://www.semiconductors.philips.com/acrobat/various/I2C_Bus Specification _{—}3.pdf. When internal connection 64 is an I2C connection, transmitter 32, receiver 34, and microcontroller 36 each include an I2C interface as described by the Phillips reference above. In one embodiment, optical transceiver module 30 conforms to the SFF-8074i Specification for Small Form Pluggable (SFP) Transceivers which is incorporated herein by reference. The SFF-8074i Specification is available at http://www.sffcommitte.com, or at ftp://ftp.seagate.com/sff/.

Transmitter 32 includes a laser 72, a laser output power sensing circuit 74, a laser bias current sensing circuit 75, a laser bias current control circuit 76, a laser modulation current control circuit 77, a temperature sensing circuit 78, a voltage sensing circuit 80, and a memory block 82. Laser bias current control circuit 78 controls the average optical power of laser 72, while laser modulation current control circuit 77 controls A/C modulation. In one embodiment, transmitter 32 is an integrated circuit. In one embodiment, laser 72 is a vertical cavity surface emitting laser (VCSEL) which is connectable to and provides an optical output signal via optical fiber 42. In one embodiment, memory block 82 is a static random access memory (SRAM) device. In one embodiment, transmitter 32 is connectable to an external host 84 via an external connection 86. External connection 86 is any suitable type of serial or parallel connection, such as a two-wire serial connection. One suitable two-wire serial connection is an I2C connection as provided by the I2C-Bus Specification available from Phillips Semiconductor at http://www.semiconductors.philips.com/acrobat/various/I2C_Bus_Specification _{—}3.pdf. The host 84 may be a customer interface or a test apparatus. When external connection 64 is an I2C connection, transmitter 32 and host 84 include an I2C interface as described the Phillips reference. When internal connection 64 and external connection 86 are configured as I2C connections, transmitter memory block 82 is utilized as a buffer, and microcontroller 36 and host 84 communicate via internal connection 64, memory block 82, and external connection 86 using standard I2C protocol.

Laser output power sensing circuit 74 is configured to measure and provide a value representative of average optical output power provided by laser 72. In one embodiment, laser output power sensing circuit 74 comprises a photodiode that samples the optical output signal provided by laser 72 and provides a current having a value representative of the optical output power of laser 72. Laser bias current sensor 76 is configured to measure and provide to a value representative of an average bias current of laser 72. Temperature sensor 78 is configured to measure and provide a value representative of the temperature of optical transceiver module 30. Voltage sensing circuit 80 is configured to measure and provide a value representative of a supply voltage 92 to transmitter 32. The representative values described above are provided to microcontroller 36 via internal connection 64.

Receiver 34 further includes light detecting element 44 and an optical input power sensing circuit 88. In one embodiment, receiver 34 is an integrated circuit. In one embodiment, light-detecting element 44 is a PIN diode 88 which is connectable to and receives an optical input signal via optical fiber 46. Input power sensing circuit 88 is configured to measure and provide to microcontroller 36 via internal connection 64 a value representative of an average power or a peak-to-peak power of an optical input signal received via optical fiber 46.

In order to be made operational, optical transceiver module 30 must first be initialized and calibrated. Module initialization involves the execution of a plurality of tasks that occurs each time optical transceiver module 30 is powered-up. Examples of tasks occurring during initialization include setting a plurality of registers internal to microcontroller 36 for customer, and clearing a plurality of register internal to microcontroller 36. Calibration generally occurs as part of a manufacturing process, and involves a plurality of tasks wherein optical transceiver module 30 is uploaded with both general and module-specific customer data in order to make the module “customer ready.” In other words, optical transceiver module 30 is uploaded with data that will enable it to perform all expected tasks according design and performance requirements. In this respect, each optical transceiver module according to the present invention may be “tuned” for operation in an individual customer's unique operating environment.

After module calibration and initialization have been completed, optical transceiver module 30 is operational and capable of transmitting and receiving optical data. However, to provide reliable operation, microcontroller 36 must execute the plurality of task code modules for controlling the operation of optical transceiver module 30 based on the task code modules' assigned priority levels. In one embodiment, the priority code of transceiver operating code 48 includes a nested loop to control the timing, order, and frequency in which the plurality of task code modules are executed by microcontroller 36. In one embodiment, the priority code includes a loop counter to control the timing, order, and frequency in which the plurality of task code modules are executed by microcontroller 36.

In one embodiment, microcontroller 36 includes a plurality of operating code modules with each operating code module comprising at least one task code module. In one embodiment, the plurality of operating code modules includes at least a laser monitoring operating code-module and a system monitoring operating code module. The laser monitoring code module comprises a plurality of task code modules for monitoring and maintaining the optical output power of laser 72 at a desired target level. The system monitoring operating code module comprises a plurality of tasks for monitoring a plurality of optical transceiver module 30 operating parameters. Example operating parameters are transceiver module 30 temperature and laser 72 average bias current. Monitoring of laser 72 is a critical task of microcontroller 36 and is assigned the highest task priority level. Other tasks, such as tasks associated with the system monitoring module, are “time-partitioned” from the task of monitoring laser 72 and are not granted as significant an amount of CPU 60 processing time as is granted to tasks for controlling laser monitoring.

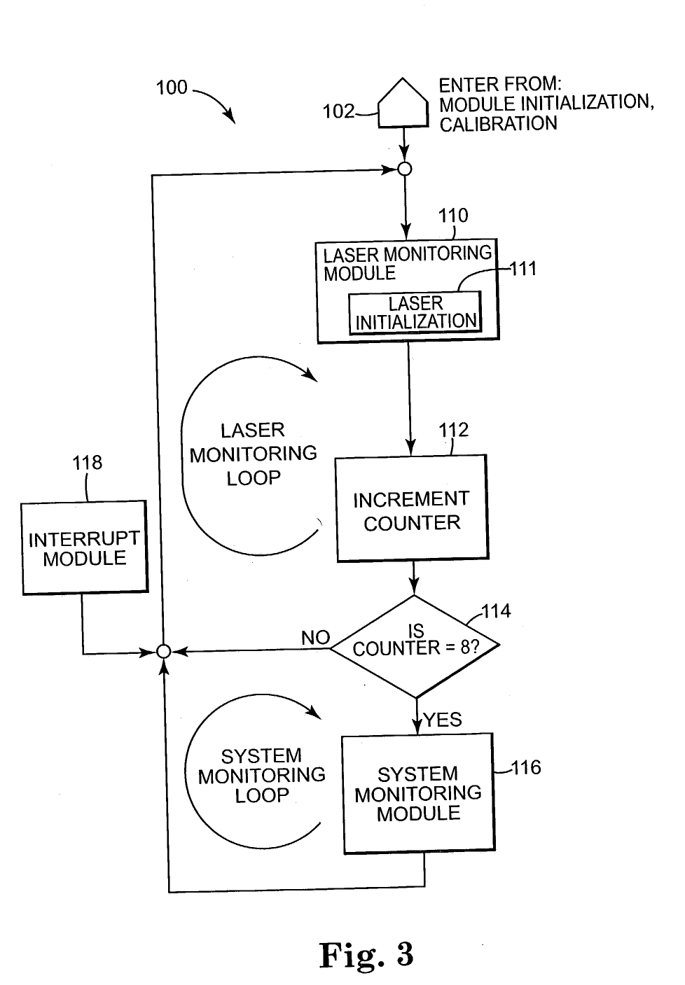

FIG. 3 is a flow diagram 100 illustrating one exemplary embodiment of a process employed by microcontroller 30 for prioritizing the execution of tasks associated with the laser monitoring and system monitoring operating code modules for controlling the operation of optical transceiver module 30 illustrated in FIG. 2. Process 100 begins at step 102 after module calibration/initialization have been completed. Process 100 then proceeds to the laser monitoring operating code module at step 110, where the operation of laser 72 is monitored and controlled. Laser monitoring module at step 110 comprises a plurality of tasks for monitoring the optical output power level of laser 72 and adjusting as required the bias current provided to laser 72 by bias control circuit 76 in order to maintain the output power at a level substantially equal to a desired target value.

The laser monitoring module at step 110 further includes a plurality of tasks for initializing laser 72 as indicated at 111. Laser initialization involves the execution of tasks for bringing up laser 72 to a desired target output power level from a power-off state. Tasks for controlling the initialization of laser 72 are generally not executed with the frequency of other laser monitoring module tasks. Typically, tasks for controlling laser initialization are only executed subsequent to an initial power-up of transceiver module 30 or after a system fault requires a shutdown and re-initialization of laser 72. The execution of tasks associated with the laser monitoring module at step 110, including tasks related to laser initialization 111, is discussed below in greater detail.

Once microcontroller 36 has executed the plurality of tasks associated with the laser monitoring module at step 110, process 100 moves to step 112 where a laser monitoring loop counter is incremented by a value of one. Process 100 then proceeds to step 114, where microcontroller 36 queries whether the loop counter is equal to a threshold value. In one embodiment, the threshold value for the laser monitoring loop counter is eight. While process 100 indicates a loop counter having a threshold value of “8” at step 114, this value can be increased or decreased according to the amount of CPU 60 processing time desired to be allotted to the laser monitoring operating code module tasks. At step 114, if the loop counter is less than eight, process 100 returns to step 110 where microcontroller 36 again executes the plurality of tasks of the laser monitoring module. If the loop counter has a value of eight, microcontroller 36 deems laser 72 to be sufficiently stable, and process 100 proceeds to step 116 to perform the plurality of tasks associated with the system monitoring operating code module.

The system monitoring module at step 116 comprises a plurality of tasks for monitoring and adjusting system operating parameters that assist in controlling the operation of optical transceiver module 30. While a variety of values are monitored and adjusted, the tasks are primarily associated with adjusting optical transceiver module 30 system operating parameters for environmental conditions, and for correcting system errors. After microcontroller 36 executes at least one task of the system monitoring operating code module, microprocessor 36 sets the laser monitoring loop counter to zero and process 100 returns to step 110 to once again begin executing tasks for monitoring laser 72. The execution of system monitoring operating code module tasks occurring at step 116 is discussed in greater detail below.

Interrupt operating code module 118 comprises a plurality of task code modules for controlling a plurality of tasks executed in response to various types of interrupt signals received by microcontroller 36 from various sources. Microcontroller 36 responds to an interrupt signal by initially suspending the laser and system monitoring task prioritization process to determine the type of interrupt signal received. Depending on the type interrupt signal, microcontroller 36 either immediately executes the corresponding plurality of task code modules before resuming the laser and system monitoring task prioritization process, or executes them with other task code modules based on their assigned priority level. Interrupt module 118 is discussed in greater detail below.

Flow diagram 100 of FIG. 3 illustrates the priority given by microcontroller 36 to performing tasks associated with the monitoring of laser 72 as compared to tasks associated with system monitoring tasks. Thus, flow diagram 100 reflects the critical nature of monitoring and controlling the power of the optical output signal provided by laser 72. With the laser monitoring loop counter at a value of eight, tasks associated with the laser monitoring code module are executed eight times for every one time a task associated with the system monitoring module is executed.

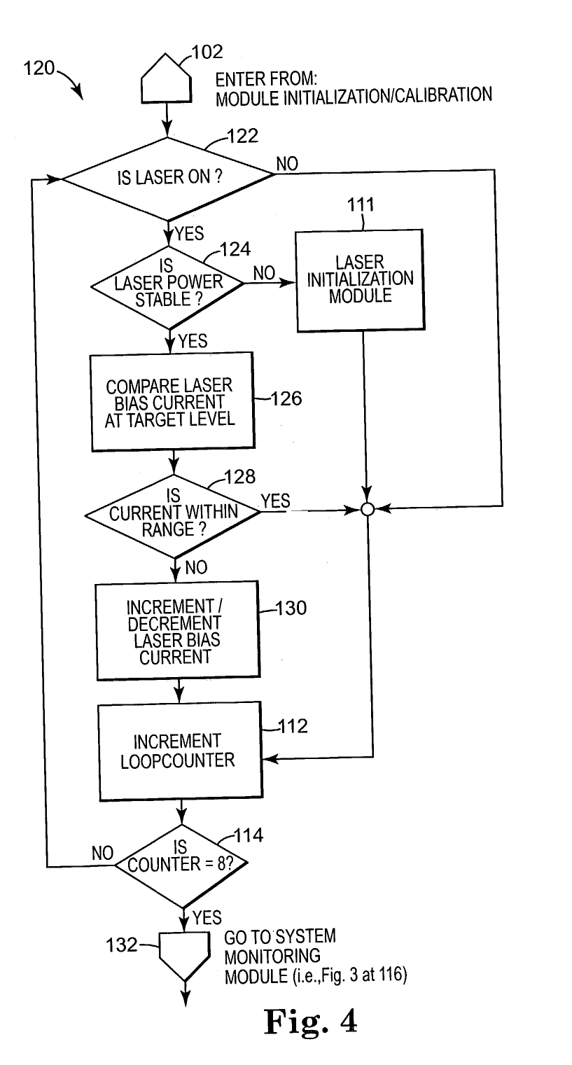

FIG. 4 is a flow diagram illustrating one exemplary embodiment of a process 120 for monitoring laser 72 as discussed generally at steps 112 and 114 of FIG. 3. Process 120 begins at step 102, after calibration and initialization of optical transceiver module 30 have been completed. Process 120 then proceeds to step 122 where microcontroller 36 queries whether laser 72 is on. If the answer to the step 122 query is “yes,” process 120 proceeds to step 124.

At step 124, microcontroller 36 determines whether the output power of laser 72 is stable. Microcontroller reads from laser output power sensing circuit 74 a value that is representative of the present output power level of laser 72. Microcontroller 36 then compares the value representative of the present output power level of laser 72 to a desired output power range for laser 72 stored in memory block 62. If value representative of the present output power is not within the desired output power range, process 120 proceeds to the laser initialization module at step 111. As described above, laser initialization involves executing a plurality of tasks for bringing up laser 72 as quickly as possible from a power off condition to providing an output signal having a power level within a desired range. Initialization of laser 72 is discussed in greater detail below. Once laser 72 has been initialized at step 111, process 120 proceeds to step 112.

If the value representative of the present output power of laser 72 at step 124 is within the desired range stored in memory block 62, process 120 proceeds to step 126. At step 126, microcontroller 36 determines whether the laser bias current is within a desired target range. Microcontroller 36 reads from laser bias current sensing circuit 75 a value that is representative of the present bias current level of laser 72 and converts the representative value to a real world value. Microcontroller 36 then compares the real world value of the present biasing current to a desired bias current target range stored in memory block 62. If the present bias current level is within the desired target range, process 120 proceeds to step 112.

If the present bias current level is not within the desired target range, process 120 proceeds to step 130. If the bias current level is less than the desired target range, microcontroller 36 causes laser bias current control circuit 76 to increase the laser bias current by a predetermined incremental amount. If the bias current level is greater than the desired target range, microcontroller 36 causes laser bias current control circuit 76 to decrease the laser bias current by the predetermined incremental amount. After the bias current has been increased or decreased, process 120 proceeds to step 112.

At step 112, microcontroller 36 increments the laser monitoring loop counter by a value of one. Process 120 then proceeds to step 114 where microcontroller 36 queries whether the loop counter has a value of eight. As described previously, while process 120 indicates a loop counter having a threshold value of eight, this value can be increased or decreased according to the amount of CPU 60 processing time is desired to be allotted to laser monitoring. If the monitoring loop counter has a value less than eight, process 120 returns to step 122 to continue executing tasks associated with monitoring of laser 72. If the monitoring loop counter has a value of eight, laser 72 is deemed to be sufficiently stable, and process 120 proceeds to step 132 at which point tasks associated with the system monitoring operating code module will be executed.

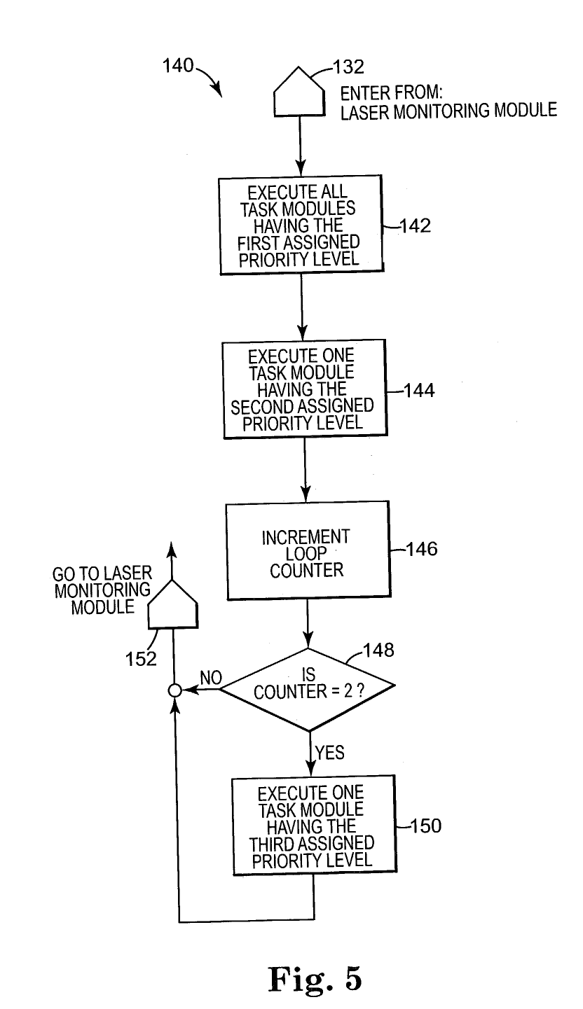

In FIG. 5, a flow diagram illustrating one exemplary embodiment of a system monitoring process 140 for optical transceiver 30 according to the present invention. System monitoring comprises a plurality of task code modules primarily for monitoring and adjusting various transceiver module 30 operating parameters for environmental changes, correcting system errors, and for maintenance. In one embodiment, the plurality of system monitoring task code modules is subdivided to form three groups, with the first group being assigned a first priority level, the second group being assigned a second priority level, and the third group being assigned a third priority level, wherein the first group comprises task code modules deemed to have the highest priority and those in the third group deemed to have the lowest priority.

System monitoring process 140 begins at step 132 after a laser monitoring process, such as laser monitoring process 120, has deemed laser 72 to be sufficiently stable so that microcontroller 36 to devote to CPU 60 processing time to system monitoring tasks without jeopardizing the operation of laser 72. Process 140 then proceeds to step 142 where microcontroller 36 executes each task code module from the first group of monitoring tasks. Examples of tasks performed by task code modules within the first group of are adjusting laser 72 output modulation based on the system temperature and setting alarms for monitoring laser 72 output power for eye safety shutdown.

When all of the task code modules of the first group have been executed, process 140 proceeds to step 144 where microcontroller 36 executes one task code module from the second group. Examples of tasks performed by task code modules within the second group are temperature adjustment of the laser output power and monitoring transmitter supply voltage fault settings. In one embodiment, microcontroller 36 maintains a circular list of task code modules from the second group and tracks which task code module was the last to be executed. When the last task code module on the list has been executed, microcontroller returns to the first task code module on the list.

After executing one task code module from the second group, process 140 proceeds to step 146, where a system monitoring loop counter is incremented by a value of one. Process 140 then proceeds to step 148, where microcontroller 36 queries whether the system monitoring loop counter is equal to a predetermined threshold value. In one embodiment, the threshold value for the system monitoring loop counter is two. While process 140 indicates a system monitoring loop counter having a value of two at step 148, this value can be increased or decreased depending on how much CPU 60 processing time is desired to be dedicated to executing system monitoring task code modules from the third group.

If the system monitoring loop counter is less than two, process 140 proceeds to step 152. If the system monitoring loop counter has a value of two, process 140 proceeds to step 150 where microcontroller 36 executes one system monitoring task code module from the third group. Examples of tasks performed by task code modules within the third group are setting and clearing alarm and warning flags. In one embodiment, microcontroller 36 maintains a circular list of task code modules from the third group and tracks which task code module was the last to be executed. When the last task code module on the list has been executed, microcontroller returns to the first task code module on the list.

After executing one task code module from the second group, microcontroller 36 sets the value of the system monitoring loop counter to zero, and process 140 proceeds to step 152. At step 152, process 140 exits to a laser monitoring process, such as laser monitoring process 120.

Interrupt operating code module at 118 comprises a plurality of task code modules for controlling a plurality of tasks executed in response to various types of interrupt signals received by microcontroller 36 from various sources. There are a plurality of types of interrupt signals, with the task code modules for controlling tasks executed in response to an interrupt signal having an assigned priority level based on the interrupt signal type. In one embodiment, interrupt signals are of a first type or a second type.

In response to receipt of an interrupt signal, microcontroller 36 initially suspends the laser and system monitoring task prioritization process to determine the type of the received interrupt signal. If the interrupt signal is of the first type, microcontroller 36 immediately executes the corresponding plurality of task code modules before resuming the laser and system monitoring task prioritization process. Examples of interrupt signals of the first type are laser disable and fault signals.

If the interrupt signal is of the second type, microprocessor 36 places the corresponding plurality of task code modules at an appropriate location within the laser and system monitoring prioritization process, and then resumes the prioritization process wherein the plurality of tasks associated with the interrupt signal are executed with other task code modules based on their assigned priority level. Examples of interrupt signals of the second type are host requests to write data to a memory.

In order to provide a quality optical transceiver module, one task which must be performed flawlessly is starting, or initializing the laser. Laser initialization involves the execution of a plurality of tasks for bringing up laser 72 as quickly as possible from a power off condition to providing an optical output signal having a power level within a desired range. Laser initialization generally occurs subsequent to transceiver module 30 being powered up, or after a transceiver system fault or disable had been removed.

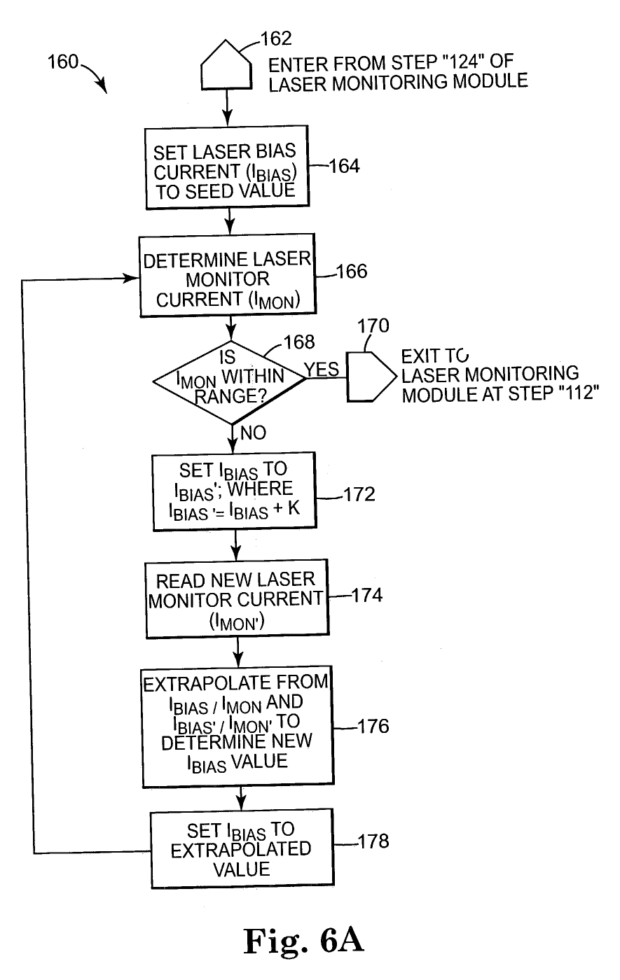

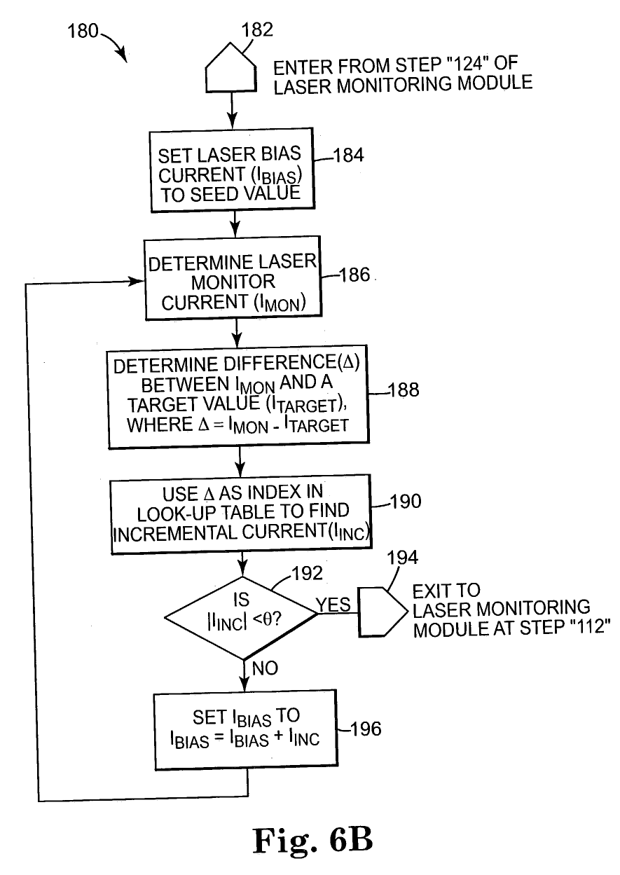

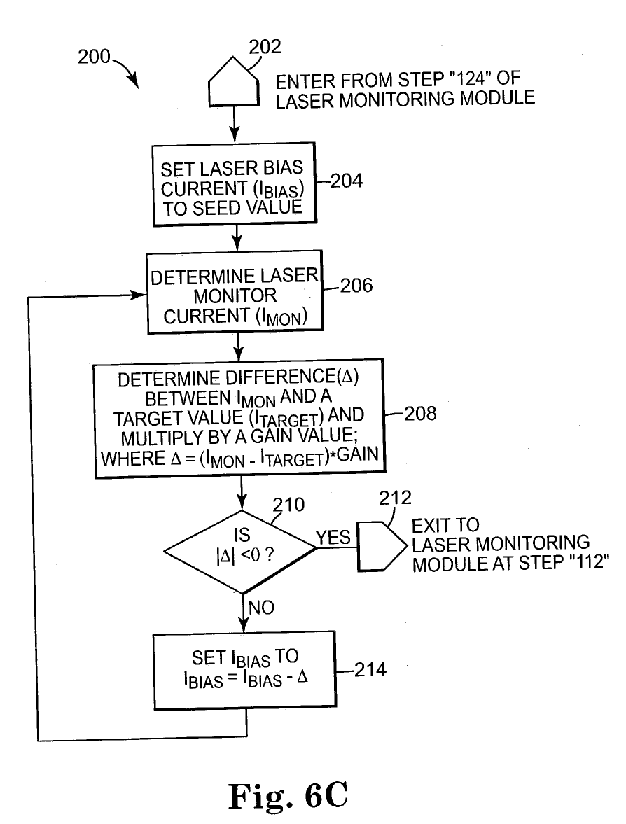

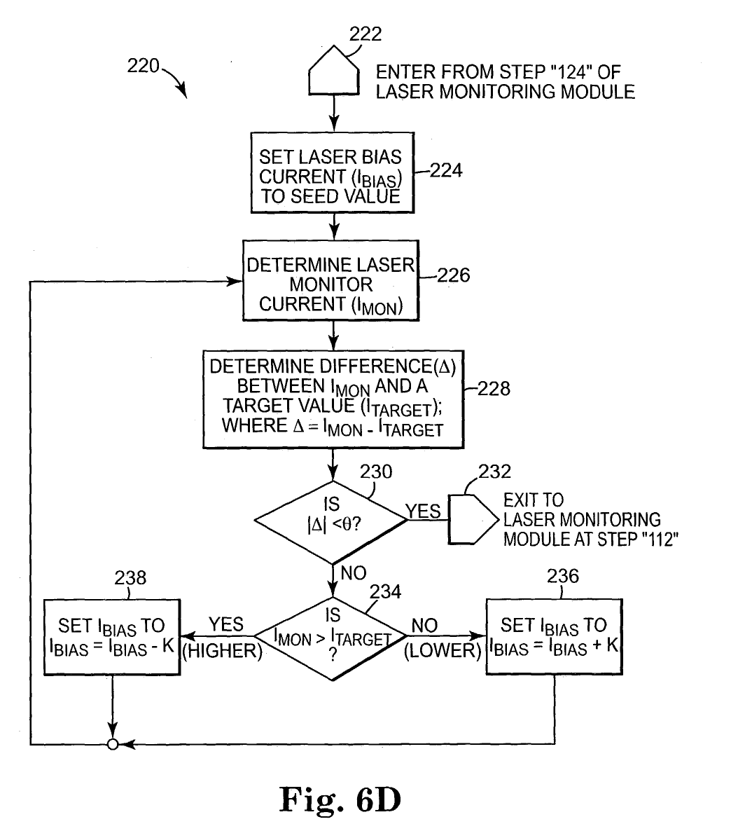

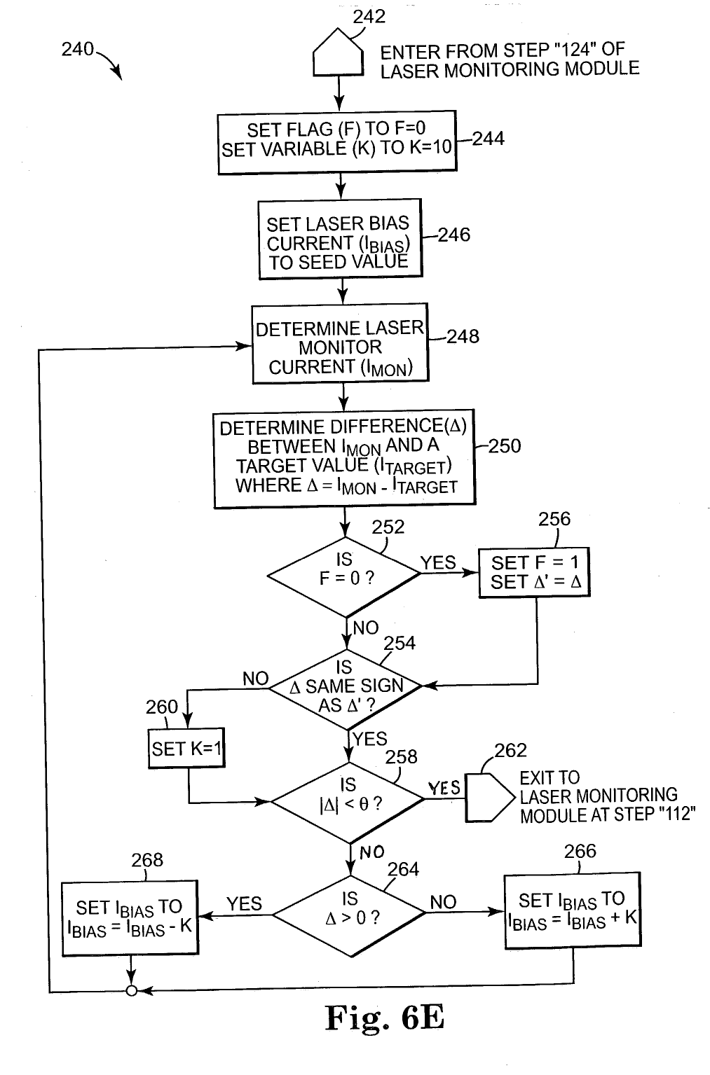

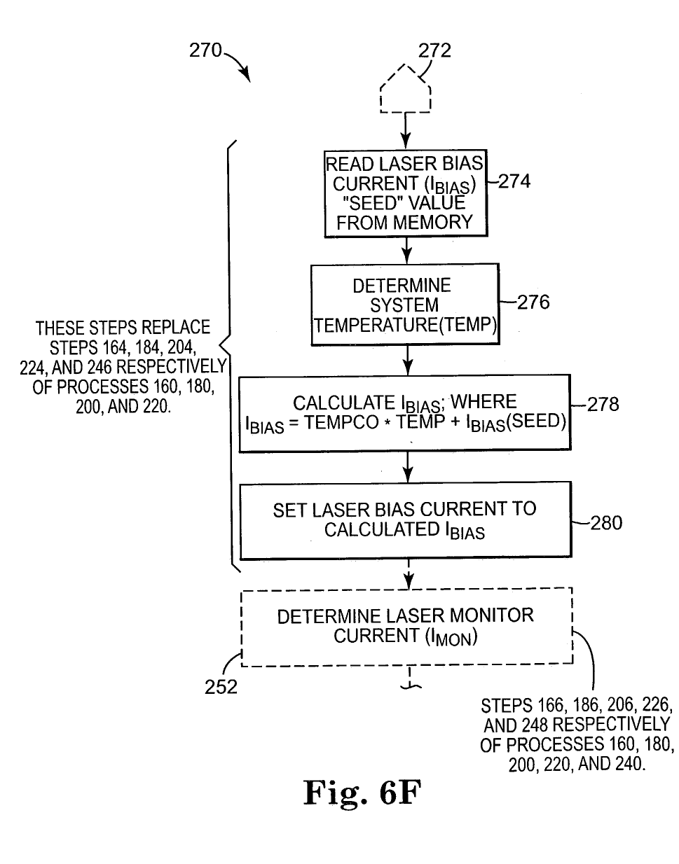

FIG. 6A is a flow diagram illustrating one exemplary embodiment of a process 160 for initializing laser 72 according to the present invention. Process 160 begins at step 162 after a laser monitoring process determines that laser 72 output power is not stable, such as at step 124 of laser monitoring process 120 illustrated by FIG. 2. Process 160 then proceeds to step 164 where microcontroller 36 reads a laser bias current seed value from memory block 62. The seed value is a value of laser bias current that resulted in laser 72 producing an optical output signal at manufacturer that had an output power level within a desired output power level target range. Microcontroller 36 stores the seed value in laser bias current control circuit 76, causing control circuit 76 to bias laser 72 with a bias current (I_{BIAS}) having a value substantially equal to the seed value.

Process 160 then proceeds to step 166 where microcontroller 36 reads a value of an optical output signal monitoring current (I_{MON}) from laser output power sensing circuit 74. In one embodiment, laser output power sensing circuit 74 comprises a photodiode that samples the optical output signal provided by laser 72 and provides the I_{MON} current level which has a value representative of the optical output power of laser 72.

Process 160 then proceeds to step 168 where microcontroller 36 compares the I_{MON} value from step 166 to a desired target range for I_{MON} stored in memory block 62. If the I_{MON} value is within the desired range, process 160 proceeds to step 170 where it exits to step 112 of laser monitoring process 120. If the I_{MON} value is not within the desired range, process 160 proceeds to step 172.

At step 172, microcontroller causes laser bias current control circuit 76 to increment the laser bias current by a constant value (K) stored in memory block 62, thereby causing laser 72 to be biased an incremented bias current (I_{BIAS′}). Process 160 then proceeds to step 174, where microprocessor 36 reads a value of the optical output signal monitoring current provided by laser output power sensing circuit after laser 72 is biased with I_{BIAS′}. The new value for the optical output signal monitoring current is referred to as I_{MON′}.

Process 160 then proceeds to step 178, where microcontroller 36 performs an mathematical extrapolation using the values of I_{BIAS}, I_{MON}, I_{BIAS′}, and I_{MON′} to calculate a desired level for the laser bias current that will cause laser 72 to provide an optical output signal having an output power level that will result in the output signal monitoring current (I_{MON}) to be within the desired target range. Process 160 then proceeds to step 178, where microcontroller 36 stores the calculated value for the laser bias current in laser bias control circuit 76. Laser bias current control circuit 76 then biases laser 72 with the calculated bias current, causing laser 72 to provide an optical output signal having an output power level substantially within the desired range.

FIG. 6B is a flow diagram illustrating one exemplary embodiment of a process 180 for initializing laser 72 according to the present invention. Process 180 begins at step 182 after a laser monitoring process determines that laser 72 output power is not stable, such as at step 124 of laser monitoring process 120 illustrated by FIG. 2. Process 180 then proceeds to step 184 where microcontroller 36 reads a laser bias current seed value from memory block 62. The seed value is a value of laser bias current that resulted in laser 72 producing an optical output signal at manufacturer that had an output power level within a desired output power level target range. Microcontroller 36 stores the seed value in laser bias current control circuit 76, causing control circuit 76 to bias laser 72 with a bias current (I_{BIAS}) having a value substantially equal to the seed value.

Process 180 then proceeds to step 186 where microcontroller 36 reads a value of an optical output signal monitoring current (I_{MON}) from laser output power sensing circuit 74. In one embodiment, laser output power sensing circuit 74 comprises a photodiode that samples the optical output signal provided by laser 72 and provides the I_{MON} current level which has a value representative of the optical output power of laser 72.

Process 180 then proceeds to step 188, where the microcontroller 36 determines the difference (Δ) between I_{MON} read during step 186 and a desired target value (I_{TARGET}) for I_{MON} stored in memory block 62. Process 180 then proceeds to step 190 where microcontroller 36 uses the Δ value as an index for a look-up table stored in memory block 62. The look-up table contains an index of predetermined incremental current values (I_{INC}) based on the Δ value that must be added to I_{BIAS} so that laser 72 will provide an optical output signal having an output power level within a desired range.

Process 180 then proceeds to step 192 where the absolute value of I_{INC} is compared to a desired value (γ) stored in memory block 62. If the absolute value of I_{INC} is less than y, process 180 proceeds to step 194 where it exits to step 112 of laser monitoring process 120 illustrated by FIG. 4. If the absolute value of I_{INC} is greater than or equal to y, process 180 proceeds to step 196. At step 196, microcontroller 36 adds the incremental current value I_{INC} to I_{BIAS} and stores this adjusted value of I_{BIAS} in laser bias control circuit 76. Bias current control circuit 76 then biases laser 72 with a bias current having a value substantially equal to the adjusted value of I_{BIAS} resulting in laser 72 providing an optical output signal having an output power level substantially within a desired range.

FIG. 6C is a flow diagram illustrating one exemplary embodiment of a process 200 for initializing laser 72 according to the present invention. Process 200 begins at step 202 after a laser monitoring process determines that laser 72 output power is not stable, such as at step 124 of laser monitoring process 120 illustrated by FIG. 2. Process 200 then proceeds to step 204 where microcontroller 36 reads a laser bias current seed value from memory block 62. The seed value is a value of laser bias current that resulted in laser 72 producing an optical output signal at manufacturer that had an output power level within a desired output power level target range. Microcontroller 36 stores the seed value in laser bias current control circuit 76, causing control circuit 76 to bias laser 72 with a bias current (I_{BIAS}) having a value substantially equal to the seed value.

Process 200 then proceeds to step 206 where microcontroller 36 reads a value of an optical output signal monitoring current (I_{MON}) from laser output power sensing circuit 74. In one embodiment, laser output power sensing circuit 74 comprises a photodiode that samples the optical output signal provided by laser 72 and provides the I_{MON} current level which has a value representative of the optical output power of laser 72.

Process 200 then proceeds to step 208, where the microcontroller 36 determines the difference (Δ) between I_{MON} read during step 206 and a desired target value (I_{TARGET}) for I_{MON} stored in memory block 62, and then multiplies the Δ value by a gain value which is also stored in memory block 62 to generate an adjusted Δ value=(I_{MON}−I_{TARGET})*(gain value).

Process 200 then proceeds to step 210 where the absolute value of the adjusted Δ value is compared to a desired value (γ) stored in memory block 62. If the absolute value of the adjusted Δ value is less than γ, process 200 proceeds to step 212 where it exits to step 112 of laser monitoring process 120 illustrated by FIG. 4. If the absolute value of the adjusted Δ value is greater than or equal to γ, process 200 proceeds to step 214. At step 214, microcontroller 36 subtracts the adjusted Δ value from I_{BIAS} and stores this adjusted value of I_{BIAS} in laser bias control circuit 76. Bias current control circuit 76 then biases laser 72 with a bias current having a value substantially equal to the adjusted value of I_{BIAS} resulting in laser 72 providing an optical output signal having an output power level substantially within a desired range.

FIG. 6D is a flow diagram illustrating one exemplary embodiment of a process 220 for initializing laser 72 according to the present invention. Process 220 begins at step 222 after a laser monitoring process determines that laser 72 output power is not stable, such as at step 124 of laser monitoring process 120 illustrated by FIG. 2. Process 200 then proceeds to step 224 where microcontroller 36 reads a laser bias current seed value from memory block 62. The seed value is a value of laser bias current that resulted in laser 72 producing an optical output signal at manufacturer that had an output power level within a desired output power level target range. Microcontroller 36 stores the seed value in laser bias current control circuit 76, causing control circuit 76 to bias laser 72 with a bias current (I_{BIAS}) having a value substantially equal to the seed value.

Process 220 then proceeds to step 226 where microcontroller 36 reads a value of an optical output signal monitoring current (I_{MON}) from laser output power sensing circuit 74. In one embodiment, laser output power sensing circuit 74 comprises a photodiode that samples the optical output signal provided by laser 72 and provides the I_{MON} current level which has a value representative of the optical output power of laser 72. Process 220 then proceeds to step 228, where microcontroller 36 determines the difference (Δ) between I_{MON} read during step 206 and a desired target value (I_{TARGET}) for I_{MON} stored in memory block 62. Process 220 then proceeds to step 230 where the absolute value of Δ is compared to a desired value (Θ) stored in memory block 62. If the absolute value of Δ is less than Θ, process 220 proceeds to step 232 where it exits to step 112 of laser monitoring process 120 illustrated by FIG. 4. If the absolute value of Δ is greater than or equal to Θ, process 220 proceeds to step 234. At step 234, microcontroller 36 compares I_{MON} to I_{TARGET} If I_{MON} is less than I_{TARGET}, process 220 proceeds to step 236. At step 236, microcontroller 36 adds a predetermined constant value (K) stored in memory block 62 to I_{BIAS} and stores this adjusted value of I_{BIAS} in laser bias control circuit 76. Bias current control circuit 76 then biases laser 72 with a bias current having a value substantially equal to the adjusted value of I_{BIAS} resulting in laser 72 providing an optical output signal having an output power level substantially within a desired range.

If I_{MON} is greater than I_{TARGET}, process 220 proceeds to step 238. At step 238, microcontroller 36 subtracts a predetermined constant value (K) stored in memory block 62 from I_{BIAS} and stores this adjusted value of I_{BIAS} in laser bias control circuit 76. Bias current control circuit 76 then biases laser 72 with a bias current having a value substantially equal to the adjusted value of I_{BIAS} resulting in laser 72 providing an optical output signal having an output power level substantially within a desired range.

FIG. 6E is a flow diagram illustrating one exemplary embodiment of a process 240 for initializing laser 72 according to the present invention. Process 240 begins at step 242 after a laser monitoring process determines that laser 72 output power is not stable, such as at step 124 of laser monitoring process 120 illustrated by FIG. 2. Process 240 then proceeds to step 244 where microcontroller 36 sets a flag (F) to a value of zero and a variable (K) to a value of ten. At step 246, microcontroller 36 reads a laser bias current seed value from memory block 62. The seed value is a laser bias current value that resulted in laser 72 producing an optical output signal at manufacture that had an output power level with a desired output power level target range. Microcontroller 36 stores the seed value in laser bias control circuit 76, causing control circuit 76 to bias laser 72 with a bias current (I_{BIAS}) having a value substantially equal to the seed value.

Process 240 then proceeds to step 248 where microcontroller 36 reads a value of an optical output signal monitoring current (I_{MON}) from laser output power sensing circuit 74. In one embodiment, laser output sensing circuit 74 comprises a photodiode that samples the optical output signal provided by laser 72 and provides the I_{MON} current level which has a value representative of the optical output power of laser 72. At step 250, microcontroller 36 determines the difference (Δ) between I_{MON} read during step 206 and a desired target value (I_{TARGET}) for I_{MON} stored in memory block 62.

Process 240 then proceeds to step 252, where microcontroller 36 queries whether flag (F) is equal to zero. If the answer is “no,” process 240 proceeds to step 254. If the answer is “yes,” process 240 proceeds to step 256 where microcontroller 36 sets the value of flag (F) to a value of one, and the value of a variable (Δ′) equal to the difference Δ.

At step 254, microcontroller 36 queries whether the sign of the difference A is the same as the sign of the variable Δ′. If the answer is “yes,” process 240 proceeds to step 258. If the answer is “no,” process 240 proceeds to step 260 where microcontroller 36 sets the variable K to a value of one.

At step 258, microcontroller 36 queries whether the absolute value of Δ is less compared to a desired value (Θ) stored in memory block 62. If the absolute value of Δ is less than Θ, process 240 proceeds to step 262 where it exits to step 112 of laser monitoring process 120 illustrated by FIG. 4. If the absolute value of Δ is greater than or equal to Θ, process 240 proceeds to step 264.

At step 264, microcontroller 36 queries whether the difference Δ is greater than a value of zero. If Δ is less than zero, process 240 proceeds to step 266 where microcontroller 36 adds the value of variable K to I_{BIAS} and stores this adjusted value of I_{BIAS} in laser bias control circuit 76. If Δ is greater than zero, process 240 proceeds to step 268 where microcontroller 36 subtracts the value of variable K from I_{BIAS} and stores this adjusted value of I_{BIAS} in laser bias control circuit 76. Laser bias control circuit 76 then biases laser 72 with a bias current having a value substantially equal to the adjusted value of I_{BIAS}, and process 240 returns to step 248.

One advantage to using a laser, such as laser 72, it that it provides an optical output signal having a far higher power level than a light emitting diode (LED) or other light emitting element, especially when the optical signal is directed into a small-core optical fiber, such as optical fiber 42. One disadvantage is that the optical output power of a laser is temperature dependent. For instance, a laser biased with a bias current having a set value will provide an optical signal having a first power level at a first temperature and an optical signal having a second power level at a second temperature.

With this in mind, one method of improving the laser bias current seed value stored in memory block 62 is a bias current value that resulted in laser 72 providing an optical signal having a power level within a desired range at a temperature value present when optical transceiver module was manufactured and tested. The likelihood that the temperature of optical transceiver 30 when laser 72 is initialized will match the temperature at manufacturing is small. Thus, one way of improving laser initialization processes 160, 180, 200, and 220 as illustrated respectively by FIGS. 6A, 6B, 6C, 6D is to use a current value of the temperature at initialization of laser 72 as provided by temperature sensing circuit 78 to adjust the laser bias current seed value stored in memory block 62 prior to storing it in laser bias current control circuit 76.

FIG. 6F is a flow diagram illustrating one exemplary embodiment of a process 270 for adjusting the laser bias seed value stored in memory block 62 based on the temperature of optical transceiver module 30 in order to provide a laser biasing current that will result in laser>72 providing an optical signal at initialization that is closer to a desired target range. Process 270 replaces steps 164, 184, 204, 224, and 246 respectively of laser initialization processes 160, 180, 200, 220, and 240.

Process 270 begins at step 272 after a laser monitoring process determines that laser 72 output power is not stable, such as at step 124 of laser monitoring process 120 illustrated by FIG. 2. Process 270 then proceeds to step 274 where microcontroller 36 reads the laser bias current seed value (I_{BIAS}) from memory block 62. Process 270 then proceeds to step 276 where microcontroller 36 reads a temperature value (TEMP) from temperature sensing circuit 78 that is indicative of the current temperature of laser 72.

Process 270 then proceeds to step 278 where microcontroller 36 determines a temperature-adjusted value for I_{BIAS} that is equal to the seed value of I_{BIAS} plus the product of the multiplication of the current laser temperature (TEMP) and a temperature constant (TEMPCO) stored in memory block 62. Process 270 then proceeds to step 280 where microprocessor 36 stores the temperature-adjusted value for I_{BIAS} in laser bias control circuit 76. Laser bias control circuit 76 then biases laser 72 with the temperature-adjusted value of I_{BIAS}.

Process 270 then proceeds to step 282, which is the equivalent of steps 166, 186, 206, 226, and 248 respectively of laser initialization processes 160, 180, 200, 220, and 240. By incorporating process 270 as described above, laser initialization processes 160, 180, 200, 220, and 240 as illustrated by FIGS. 6A, 6B, 6C, 6D, and 6E, respectively, will be improved and laser 72 will more quickly provide an optical output signal that is within the desired power range.

In conclusion, by utilizing a controller in conjunction with a transmitter and a receiver, optical transceiver module 30 according to the present invention provides a more flexible optical transceiver design than conventional optical transceivers utilizing “hard coded” integrated circuits. For example, optical transceiver 30 is better configured to and more easily provides monitoring of and reporting to users of transceiver operating characteristics, such as the transceiver's internal temperature, laser output power, and laser biasing. Furthermore, by employing a priority code for executing transceiver module 30 control tasks in order of an assigned priority level, controller 36 provides for reliable transceiver operation by ensuring that higher priority tasks are completed without fail on a frequent basis while still ensuring that lower priority tasks are completed in a timely fashion.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An optical transceiver module for optical communication, comprising:
a transmitter;
a receiver; and
a controller coupled to the transmitter and the receiver and including a transceiver operating code comprising:
a plurality of task code modules with each task code module containing instructions for performing at least one task of a plurality of tasks for controlling the optical transceiver module, wherein each task code module has an assigned priority level; and
a priority code configured to control the order in which the controller executes the plurality of task code modules based on the assigned priority levels.

2. The optical transceiver module of claim 1, wherein the priority code includes a nested-loop to control the order in which the controller executes the plurality of task code modules.

3. The optical transceiver module of claim 1, wherein the priority code includes a loop counter to control the order in which the controller executes the plurality of task code modules.

4. The optical transceiver module of claim 1, wherein the controller includes a plurality of operating code modules wherein each operating code module comprises at least one task code module.

5. The optical transceiver of claim 4, wherein the plurality of operating code modules comprises at least one of the following operating code modules:
a laser monitoring operating code module; and
a system monitoring operating code module.

6. The optical transceiver module of claim 5, wherein the system monitoring operating code module comprises:
a plurality of task code modules, wherein the task code modules are subdivided to form a first task code module group comprising a first type of task code module having a first assigned priority level, a second task code module group comprising a second type of task code module having a second assigned priority level, and a third task code module group comprising a third type of task code module having a third assigned priority level

7. The optical transceiver module of claim 6, wherein the controller is configured to complete the first type of task code module having a first assigned priority level within a first time period, to complete the second type of task code module having a second assigned priority level within a second time period, and to complete the third type of task code module having a third assigned priority level within a third time period.

8. The optical transceiver module of claim 7, wherein the first time period is less than 100 milliseconds, the second time period is less than 300 milliseconds, and the third time period is less than 3 seconds.

9. The optical transceiver module of claim 6, wherein the controller is configured to execute the first type of task code module ten times as frequently as the second type of task code module and fifty times as frequently as the third type of task code module.

10. The optical transceiver module of claim 4, wherein the plurality of operating code modules comprises at least one of the following operating code modules:
an interrupt operating code module comprising:
at least one task code module for controlling at least one task in response to at least one interrupt signal.

11. The optical transceiver module of claim 10, wherein an assigned priority level of the at least one task code module of the interrupt operating code module is based on the type of interrupt signal to which the at least one task code module responds.

12. The optical transceiver module of claim 11, wherein the at least one task code module of the interrupt operating code module responding to a first type of interrupt signal is placed in order with other task code modules.

13. The optical transceiver module of claim 11, wherein the at least one task code module of the interrupt operating code module responding to a second type of interrupt signal is placed ahead of all other task code modules.

14. The optical transceiver module of claim 1, wherein the controller is coupled to the transmitter and receiver via an internal bus.

15. The optical transceiver module of claim 14, wherein the internal bus is a two-wire serial bus.

16. The optical transceiver module of claim 1, wherein the transmitter is connectable to an external host device via an external bus.

17. The optical transceiver module of claim 16, wherein the external bus is a two-wire serial bus.

18. The optical transceiver module of claim 16, wherein the external host device is a testing apparatus for testing a plurality of operating characteristics of the optical transceiver module.

19. The optical transceiver module of claim 1, wherein the controller comprises:
a microcontroller comprising:
a memory block containing the transceiver operating code; and
a central processing unit (CPU) for executing the code.

20. The optical transceiver module of claim 19, wherein the memory block is an electrically erasable programmable read only memory (EEPROM) device.

21. The optical transceiver module of claim 19, wherein the memory block is a flash memory device.

22. The optical transceiver module of claim 1, wherein the transmitter is an integrated circuit.

23. The optical transceiver module of claim 1, wherein the transmitter comprises:
a light-emitting element and is configured to receive and convert an electrical signal to an optical signal.

24. The optical transceiver module of claim 1, wherein the receiver comprises:
a light-detecting element and is configured to receive and convert an optical signal to an electrical signal.

25. The optical transceiver module of claim 23, wherein the light-emitting element is a laser.

26. The optical transceiver module of claim 23, wherein the light-emitting element is a vertical cavity surface emitting laser (VSCEL).

27. The optical transceiver module of claim 25, wherein the transmitter further comprises:
a power sensing circuit configured to measure and provide a value of the laser's average power.

28. The optical transceiver module of claim 25, wherein the transmitter further comprises:
a bias current sensing block configured to measure and provide a value of the laser's average bias current.

29. The optical transceiver module of claim 1, wherein the transmitter further comprises:
a voltage sensing circuit configure to measure and provide a value of a temperature of the transmitter.

30. The optical transceiver module of claim 1, wherein the transmitter further comprises:
a voltage sensing circuit configured to measure and provide a value of a supply voltage to the transmitter.

31. The optical transceiver module of claim 1, wherein the transmitter further comprises:
a memory block.

32. The optical transceiver module of claim 31, wherein the memory block is an static random access memory (SRAM) device.

33. The optical transceiver module of claim 1, wherein the receiver circuit is an integrated circuit.

34. The optical transceiver of claim 24, wherein the light-detecting element is a positive-intrinsic-negative photodiode (PIN diode).

35. The optical transceiver module of claim 1, wherein the receiver further comprises:
a power sensing circuit configured to measure and provide a value of the power of a received optical signal.

36. A method of controlling an optical transceiver module, the method comprising:
assigning a priority level to each task code module of a plurality of task code modules; and
executing the task code modules in a controller in an order based on the assigned priority levels to perform a plurality of tasks for controlling the optical transceiver module.

37. The method of claim 36, further comprising:
executing a nested-loop to control the order in which the task code modules execute.

38. The method of claim 36, further comprising:
executing a loop counter to control the order in which the task code modules execute.

39. The method of claim 36, further comprising:
providing a plurality of operating code modules wherein each operating code module comprises at least one task code module.

40. The method of claim 39, wherein providing the plurality of operating code modules further comprises:
providing at least one of the following operating code modules:
a laser monitoring operating code module; and
a system monitoring operating code module.

41. The method of claim 40, wherein providing the system monitoring operating code module further comprises:
providing a plurality of task code modules; and
subdividing the task code modules to form a first task code module group comprising a first type of task code module having a first assigned priority level, a second task code module group comprising a second type of task code module having a second assigned priority level, and a third task code module group comprising a third type of task code module having a third assigned priority level.

42. The method of claim 40, further comprising:
completing the first type of task code module having a first assigned priority level within a first time period;
completing the second type of task code module having a second assigned priority level within a second time period; and
completing the third type of task code module having a third assigned priority level within a third time period.

43. The method of claim 41, further comprises:
providing a first time period of less than 100 milliseconds, a second time period of less than 300 milliseconds, and a third time period of less than 3 seconds

44. The method of claim 40, further comprising:
executing the first type of task code module ten times as frequently as the second type of task code module and fifty times as frequently as the third type of task code module.

45. The method of claim 36, wherein providing the plurality of operating code modules comprises:
providing at least an interrupt operating code module comprising:
at least one task code module for controlling at least one task in response to at least one interrupt signal.

46. The method of claim 45, further comprising:
assigning a priority level to the at least one task code module of the interrupt operating code module based on the type of interrupt signal to which the at least one task code module responds.

47. The method of claim 46, further comprising:
placing the at least one task code module of the interrupt operating code module responding to a first type of interrupt signal in order with other task code modules.

48. The method of claim 46, further comprising:
placing the at least one task code module of the interrupt operating code module responding to a second type of interrupt signal ahead of all other task code modules.

49. The method of claim 1, wherein the optical transceiver module comprises a laser, and the method further comprises:
measuring and providing a value of the laser's average power.

50. The method of claim 49, further comprising:
measuring and providing a value of the laser's average bias current.

51. The method of claim 1, further comprising:
measuring and providing a value of the optical transceiver temperature.

52. The method of claim 1, further comprising:
measuring and providing a value of an optical transceiver supply voltage.

53. The method of claim 1, further comprising:
measuring and providing a value of the power of a received optical signal.

54. A networked system comprising:
a network connection;
a first optical transceiver coupled to the network connection and comprising:
a transmitter configured to provide a first optical signal;
a receiver configured to receive a second optical signal;
a controller coupled to the transmitter and receiver and including a transceiver operating code comprising:
a plurality of task code modules with each task code module containing instructions for performing at least one task of a plurality of tasks for controlling the optical transceiver and having an assigned priority level; and
a priority code configured to control the order in which the controller executes the priority of task code modules based on the assigned priority levels; and
a second optical transceiver coupled to the network connection and comprising:
a receiver configured to receive the first optical signal;
a transmitter configured to provide the second optical signal;
a controller coupled to the transmitter and receiver and including a transceiver operating code comprising:
a plurality of task code modules with each task code module containing instructions for performing at least one task of a plurality of tasks for controlling the optical transceiver and having an assigned priority level; and
a priority code configured to control the order in which the controller executes the priority of task code modules based on the assigned priority levels.

55. The networked system of claim 54, wherein the network connection comprises:
pair of optical fibers.
